(19) United States
(12) Patent Application Publication
(10) Pub. No.: US 2011/0127205 A1
(43) Pub. Date: Jun. 2, 2011

(54) SEDIMENTATION BASIN FOR SEWAGE TREATMENT PLANTS

(76) Inventor: Swantje Mignon Schlederer, Grafing (DE)

(21) Appl. No.: 12/674,621

(22) PCT Filed: Aug. 21, 2008
(86) PCT No.: PCT/EP2008/060970

§ 371 Date: Apr. 19, 2010

(30) Foreign Application Priority Data
Aug. 22, 2007 (EP) 07114798.7

(51) Int. Cl. B01D 21/00; B01D 21/24

(52) U.S. Cl. 210/209; 210/521

(57) ABSTRACT

The invention relates to a sedimentation basin for sewage treatment plants, the sedimentation basin separating materials such as sand, rocks or broken glass, from waste water, which materials settle by gravitational action. The waste water is introduced in the inlet region of the sewage treatment plant. The sedimentation basin is provided with flow guide walls having a wave or meander shape, a plurality thereof being disposed vertically adjacent to each other and parallel to the main flow direction of the sedimentation basin. The slowing of the flow caused by this arrangement results in improved sedimentation that occurs in an efficient and compact basin requiring less space.

### BACKGROUND OF THE INVENTION

The invention relates to a sedimentation basin for a sewage treatment plant for the purification of waste water collected in drain systems and transported to a sewage treatment plant.

Biological, chemical and mechanical (also referred to as physical) methods are used to remove undesirable constituents from waste waters. Accordingly, modern sewage treatment plants have three stages, with special emphasis being placed on a particular method in each purification stage.

The raw waste water that is fed from the drains comprises a mixture of different admixtures of organic and non-organic matter, which can be either soluble or insoluble and are carried along by the water, which forms the primary constituent. Particularly after heavy rainfall, which produces large amounts of sewage water, the waste water entrains considerable amounts of coarser, settleable impurities, such as sand, rocks and broken glass, and a variety of organic substances. This matter can result in disruption (wear, clogging) of the operation of the sewage treatment plant, and must therefore be removed in advance from the flow of waste water that is to be purified.

For this purpose, the feed region of the sewage treatment plant is equipped, not only with a collection tank for receiving the untreated waste water fed from the drains, but also a first settling tank for the coarse admixtures, which settle out because the density thereof is higher than that of water. Such sedimentation basins are also known as “sand traps”. They are employed in a variety of design embodiments, such as, for example:

elongate sand collectors, described in DE 41 21 392 A1;

aerated sand traps, whereby oils and fats floating on the surface can be separated, as set forth in DE 35 29 760 C2; and

circular sand traps, for example according to DE 100 12 379 A1.

Aerating the sand trap, preferably from the bottom of the settling tank, produces a turbulent flow and lowers the density of the waste water, causing the heavy, mineral portions (primarily sand) to settle at the bottom of the tank. Such a sand trap is disclosed, for example, in DE 198 30 082 C1. With a deep sand trap, the waste water flows into the tank from above. Because of the depth, the waste water has a relatively long residence time, and thus the heavy sand can settle at the bottom of the tank. The tank bottom is usually configured as a sand funnel. In modern plants, after removal of sand from the sand trap, the sand trap material is washed, for example in order to separate organic admixtures that may be present, as set forth in DE 296 23 203 U1. This measure allows for better recycling and subsequent use, for example in road construction.

Sand is separated, depending on the type of the sand trap, by gravity, such as in the elongate sand collector described in DE 41 21 392 A1, or by way of centrifugal force, such as in a circular sand trap according to DE 85 23 894 U1, or by way of a vortex sand trap, such as according to DE 198 30 082 C1 or DE 100 12 379. Rake blades or screw conveyors are frequently used for longitudinal clearing of the bottom of the settling tank. Solid matter is removed further on in the process, using a pump and grit grader; and these two parts may also be combined in one construction, in the form of a grit-grader worm.

A sedimentation basin for sewage treatment plants designed as an elongate sand collector is known from DE 41 21 392 A1, wherein a plurality of vertically disposed flat metal sheets are oriented parallel to the direction of flow, in a region adjacent to the discharge of the basin. These installations are provided in a region in which sand has already settled and are intended to increase friction, so as to slow the flow. However, this measure is only used to maintain the water level approximately constant over the length of the drain channel

Guiding a flow through planar installations is known from DE 36 41 365 C2, where the planar installations are disclosed as electrode plates and the flow is guided in a meander-like fashion in order to achieve a longer application time for an electrical field for floating dirt particles in the waste water. At the same time, sand entrained in the waste water is separated. The meanders formed by the installations run in the vertical direction and have no influence on deposition of the sand.

DE 297 12 469 U1 describes an apparatus for separating granular matter from a fluid, particularly, a coolant enriched with chips, in the metal-working industry. In this apparatus the fluid flow is alternately reversed from the bottom to the top by guide plates arranged in a zig-zagging arrangement, whereby heavy particles are deposited on the bottom and can be removed by a sliding scraper.

The sedimentation rate for granular material such as sand or rocks is dependent, in a complicated manner, on the specific radius of the material particles. If the radius is small, the sedimentation rate is low, and varies according to the square of the particle radius. If the particles are larger, the sedimentation rate is high, and is proportional to the root of the particle radius. In general terms, waste water carries settleable materials having a wide range of grain sizes, which should be separated in the sedimentation basin as completely as possible. Because of the different settling rates for the individual grain sizes, it is necessary to ensure a sufficiently long waste water residence time in the sedimentation basin. Since the residence time depends on the flow rate of the waste water and the length of the basin, the sedimentation basin must be relatively long in order to achieve sufficient sedimentation, even with smaller grain sizes, which is shown in DE 41 21 393 A1, for example. The space requirements and material costs involved in building such a sedimentation basin can be problematic.

### SUMMARY OF THE INVENTION

It is an object of the invention to provide a more efficient sedimentation basin for sand, rocks and other settleable matter entrained by waste water, which has a high waste water throughput rate and reduced space requirements.

The present invention uses an advantageously slow waste water flow for sedimenting entrained matter having higher specific weights, and employs structure that effects forced directional changes of the flow, resulting in alternating turbulent and stagnating zones, which promote the sedimentation process.

Such directional changes occur in natural bodies of flowing water that entrain bed loads, such as sand, gravel and rocks, in regions having low gradients and therefore low flow rates. Rivers of this sort are referred to as “meanders,” taking the name from a river in Asia Minor. In general, they develop in the lower course of the body of water. The cause of the meander shape is the effect of the inertia of the water, as a result of which the outside radius of the river bend, which is referred to as the cut bank, is subject to greater erosion than the inside radius of the river bend, which is known as the point bar. Once a bend has been formed, it therefore continues to become more pronounced. Once the channel line has been diverted from the center of the river to one of the banks, a cut bank forms, which continually recedes due to erosion of the side. Opposite the cut bank, the point bar is formed, from which the river moves away depositing sediments. As a result of the meandering course of the river, the flow rate is reduced, which generally promotes sedimentation.

According to the invention, installations are introduced into the sedimentation basin which are configured as flow guide walls for the fluid, that is, the waste water to be purified, which flow guide walls provide a structured path for the fluid to flow though. “Structure” here shall be understood to mean that, contrary to the prior art according to DE 41 21 392 A1, the flow guide walls are not designed as flat metal sheets, but instead have a wave-like or meandering curved shape. Hereinafter, the terms “wave” and “meander” are used in a substantially synonymous manner. That is, the terms “wave” and “meander” generally define a surface having alternating elevations and depressions, as, for example, shown in FIG. 4 of the present specification. The terms can be used interchangeably. That is, no difference in the meaning of the terms is intended herein. The individual waves and/or meanders, of which the flow guide walls will have a plurality, do not have to be identical to each other. For example, they can differ in the distances from each other, the heights (amplitude), the curvatures, or angles, one or combinations thereof can result in a change in flow direction and/or flow properties.

By designing the flow guide walls in the form of a plurality of waves or meanders, the flow rate of the waste water being purified is reduced. Stagnation zones and vortices are created. The sediments can therefore settle quicker, and over shorter distances. Additionally, the sediments are preferably deposited on the back side of the waves or meanders, relative to the flow direction. This process is promoted by the bottom of the basin being designed in an ascending manner toward the outlet region. That is, the vertical distance over which the sediment must travel in order to be deposited is progressively reduced. The efficiency of sedimentation is increased by these attributes, and as a result the sedimentation basin can be designed and constructed considerably smaller than under the state of the art.

In order to further lower the flow rate, different surface configurations can be employed for the flow guide walls. For example, in addition to the wave or meander shape discussed above, the flow guide walls may be provided with additional relatively finer structuring, for example, nubs or dimples, or other structures protruding from the surface. For this purpose, structures directed counter to the flow, providing a “shark skin” quality, can be used. Such finer structuring can be applied, for example, by way of embossing with dies, by chemically applied coatings, or by way of thermal processes such as brazing, welding or flame spraying.

A plurality of flow guide walls are disposed in the basin, substantially parallel to each other in the main flow direction, that is, the straight path between the inlet region and the outlet region. Due to the aligned, parallel arrangement, flow channels having a substantially constant width are formed between adjoining flow guide walls. The flow channels, and therefore the waste water flows, run in a meandering fashion with alternating directional changes, resulting in the formation of flow regions which correspond to the conditions of a cut bank and a point bar. In the region of the point bar, the flow rate is considerably reduced, resulting in particularly effective sedimentation.

The distances of the individual waves or meanders from each other, and the length of the wave, can be established in different ways. The distances can be, for example, constant both in the horizontal direction and in the vertical direction. However, the distances can also be varied with respect to one or both of these directions. For example, the length of the wave in the main flow direction, that is, the horizontal direction, can increase, or alternatively, it can decrease. Likewise, the length of the wave can increase in a downward direction (i.e., toward the basin bottom). The amplitudes of the waves or meanders, that is, the distances of the crests from an imaginary center line of the flow guide walls, can be dimensioned as appropriate.

A particularly preferred design for elongate basins are trapezoidal basins, wherein the width of the basin continuously increases in the main flow direction. The inlet region is located at the narrow end, while the outlet region is disposed at the opposite wide end. This basin shape further slows the flow rate of the waste water in the main flow direction, since the flow cross-section continuously increases. The reduction in the throughput rate as a result of widening the flow paths favors sedimentation because finer grains of sand having a lower sedimentation rate also have the opportunity to settle.

The trapezoidal design of the basin also provides for compensation of the influence of the bottom that ascends in the longitudinal direction of the basin. This design variant is also conducive to the sedimentation of finer grains of sand, since the vertical distance over which the settling sand grains must travel before they reach the bottom of the basin is progressively reduced.

In one embodiment, the sedimentation basin is a circular basin having an inlet region preferably located in the central region of the basin, where the sludge or sand collecting chamber, which is typically funnel-shaped, is also disposed. The outlet region is provided at the edge of the basin, for example, in the form of an overflow outlet having a duct for the waste water, from which waste water sediments have been separated, and resulting in a partially purified waste water. In this embodiment, the flow guide walls substantially originate in the inlet region and extend in the radial direction to the edge of the basin. In the case of larger basins, additional, shorter flow guide walls in the outer region can be provided, in order to compensate for the divergence of the adjoining radially extending flow guide walls, in order to maintain a constant channel width. The additional flow guide walls do not have to be oriented exactly in the radial direction. Also, it is possible to use additional flow guide walls having different lengths.

The flow guide walls according to the invention preferably extend over the entire length of the sedimentation basin, with the exception of the inlet region, which should be freely accessible from above for removing the collected sediment from the sludge collection chamber. The flow guide walls preferably extend at least from the upper edge of the basin to approximately the bottom thereof, following the contour of the bottom, and spaced at a constant distance from the bottom. According to the invention, the free space is used for the installation of purification apparatuses, such as rake blades, slides or scrapers, which can be used to feed the sediment deposited on the bottom to a sludge or sand collection chamber. The sludge or sand collection chamber typically represents the lowest region of the basin. It can be provided with a discharge line which opens into an orifice at the bottom of the basin. The discharge line is used for sand/sludge removal, such as, for example, by a spiral conveyor. In the case of circular basins, the rake blades are preferably disposed offset with respect to the radial direction and rotationally driven. In the case of rectangular elongate basins, rake blades which can be displaced in the longitudinal direction of the basin are preferred.

In a preferred embodiment, the flow guide walls can be displaced, individually or together, in the vertical direction. For this purpose, supporting apparatuses are provided for the flow guide walls, which advantageously span the sedimentation basin. These make it possible to move the flow guide walls up and down using manual or motor drives, for example, in order to set the distance to the bottom of the guide walls to the bottom of the sedimentation basin. It is advantageous to make the travel path long enough that the lower edges of the flow guide walls can at least reach over the upper edge of the sedimentation basin. In this way, the basin is freely accessible, if needed. In addition, this makes it possible to reach the flow guide walls for inspection or cleaning purposes, without having to drain the sedimentation basin. This prevents interruption of operations, particularly if maintenance work is scheduled in a period of low waste water accumulation.

Steel is the preferred material for the flow guide walls, as it has the mechanical stability and strength necessary for operations under harsh conditions in the inlet region of sewage treatment plants, and can be molded to the desired shape without difficulty. As an alternative, it is also possible to use glass fiber reinforced plastics or semi-permeable plastic membranes, for example, in the form of large-pore, reinforced non-woven fabrics, which produce a further increase in sedimentation, due to a filtration effect.

In order to increase the wear resistance, or as protection against rusting, the material employed can also be coated. If the flow guide walls are permanently installed, or if the side walls of the sedimentation basin are appropriately designed, these walls can also be made of concrete, preferably in the form of armored concrete or fiber reinforced concrete.

The shape of the sedimentation basin can be selected by the artisan. Preferred shapes include rectangular or trapezoidal elongate basins, wherein the inlet and outlet regions are disposed at smaller-sized faces, or circular basins having a central inlet region. In the case of elongate basins, the flow guide walls preferably run parallel to the longer side walls, that is, parallel to the main flow direction between the inlet and outlet regions. In the case of circular basins or circle sector shaped basins, the flow guide walls are located substantially in the radial direction.

When operating a sedimentation basin according to the invention, sedimentation can be promoted by additional measures. This includes electrical, thermal or chemical influencing of sedimentation, which can be achieved with a suitable design or by treating the flow guide walls.

Within the scope of the invention, the flow guide walls can, for example, be provided with electrostatic charges. The walls can be heated to different temperatures, or they can be chemically coated.

In order to promote sedimentation, or for rinsing the sedimentation basin and the flow guide walls, openings and/or feed lines can be provided in the region of the bottom of the sedimentation basin, by way of which gases, such as compressed air or fluids, can be introduced into the basin.

### BRIEF DESCRIPTION OF THE DRAWINGS

The invention will be described in more detail based on the figures. Shown are:

FIG. 1: a schematic illustration of a sewage treatment plant having a sedimentation basin;

FIG. 2: a schematic cross-sectional side view of a rectangular sedimentation basin according to the invention;

FIG. 3: a schematic top view of a rectangular sedimentation basin according to the invention from FIG. 2;

FIG. 4: a perspective view of a separating wall/flow guide wall according to the invention;

FIG. 5: a schematic cross-sectional side view of a sedimentation basin according to the invention, which is configured as a circular basin;

FIG. 6: a schematic top view of the circular basin from FIG. 5;

FIG. 7: a schematic top view of a circle sector shaped or trapezoidal basin according to the invention;

FIG. 8: a schematic longitudinal section of a rectangular or trapezoidal basin according to a further variant of the invention;

FIG. 9: a schematic cross-section of a rectangular or trapezoidal basin from FIG. 3;

FIG. 10: a schematic cross-section of a rectangular or trapezoidal basin according to a further embodiment of the invention; and

FIG. 11: a schematic cross-section of a pipe having flow guide walls according to a further variant of the invention.

### DETAILED DESCRIPTION OF THE INVENTION

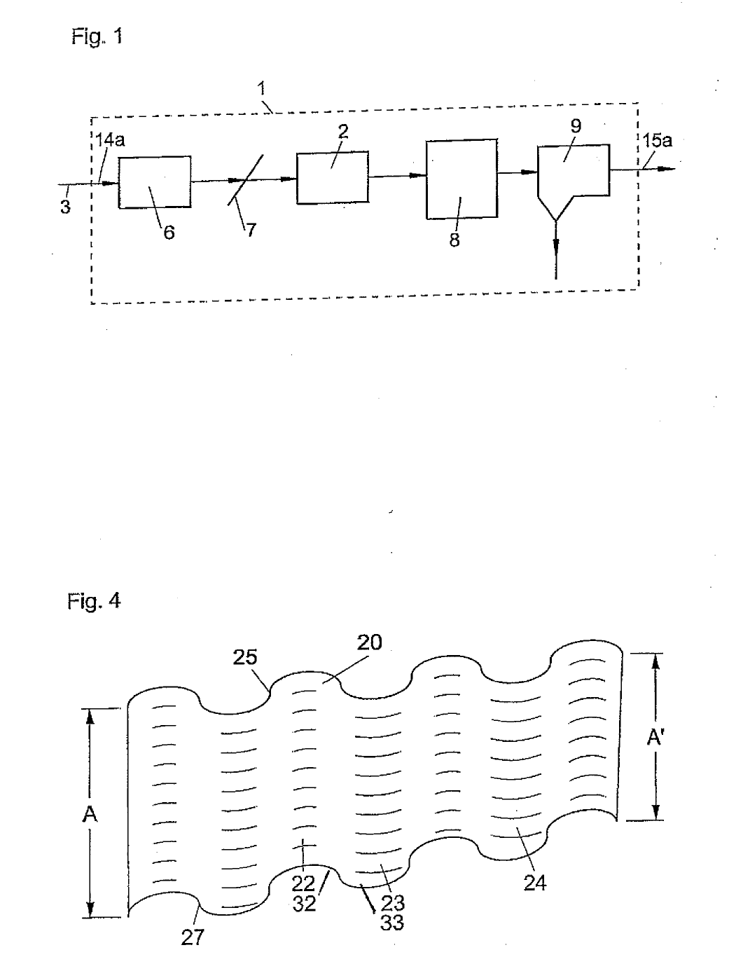

FIG. 1 shows a schematic illustration of a municipal sewage treatment plant 1, which is used to purify waste water 3 collected from drains and transported to the treatment plant. An inlet 14a leads to a collection tank 6 and then a grill 7, for sorting coarse, buoyant material, and then to a sedimentation basin 2. The purpose of the basin 2 10 is to remove coarse, settleable matter, such as sand, from the waste water. The raw waste water from which this matter has been separated enters an activated sludge basin 8, where organic and inorganic compounds are degraded by the action of microorganisms. In the secondary settling tank 9, suspended matter and other settleable impurities are precipitated as sewage sludge before the purified water flows via an outlet 15a into receiving water, typically a flowing body of water.

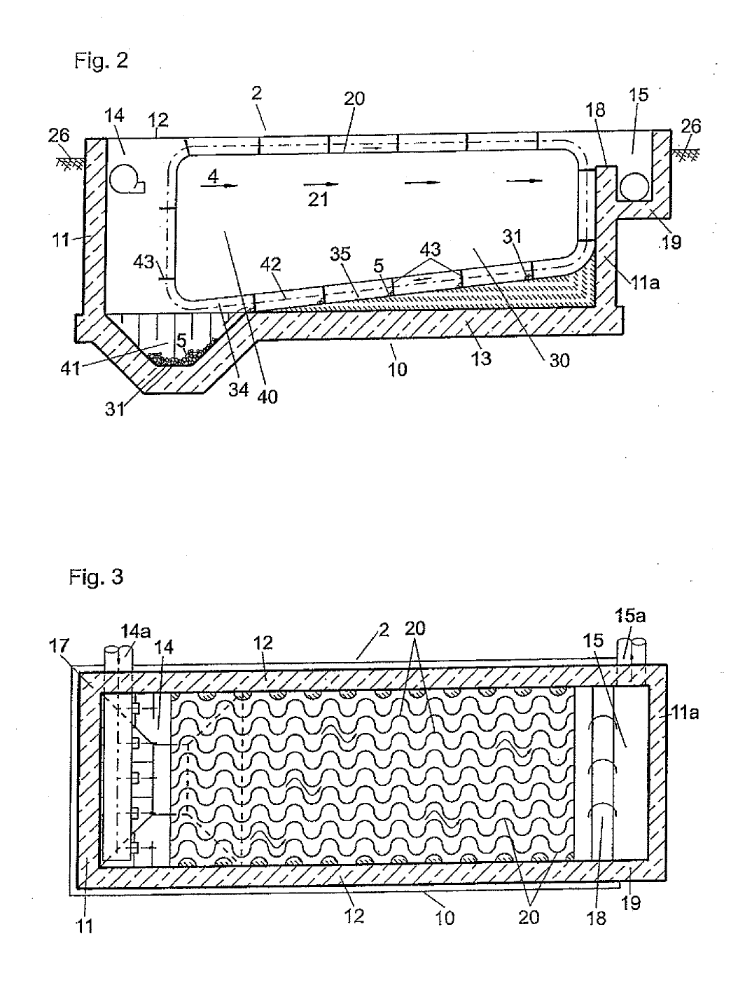

FIG. 2 shows a schematic illustration of a side view of a sedimentation basin 2,10 for sand according to the invention, configured as a rectangular elongate collection basin, which typically is recessed into the ground 26. At a face wall 11, the basin 10 comprises an inlet region 14 for the waste water 3 arriving from the grill 7 (see FIG. 1). The waste water 3 can generally be considered a fluid having admixtures 5, such as buoyant materials and settleable, non-buoyant materials. The waste water flows from the bottom 13 and, to a limited extent, from the side walls 12 of the basin 10 in the main flow direction 21 to the face wall 11a of the basin 10, opposite the inlet region 14. At face wall 11a, it flows via an overflow outlet 18 into a drain duct 19 and from there to an activated sludge basin 8 (see FIG. 1).

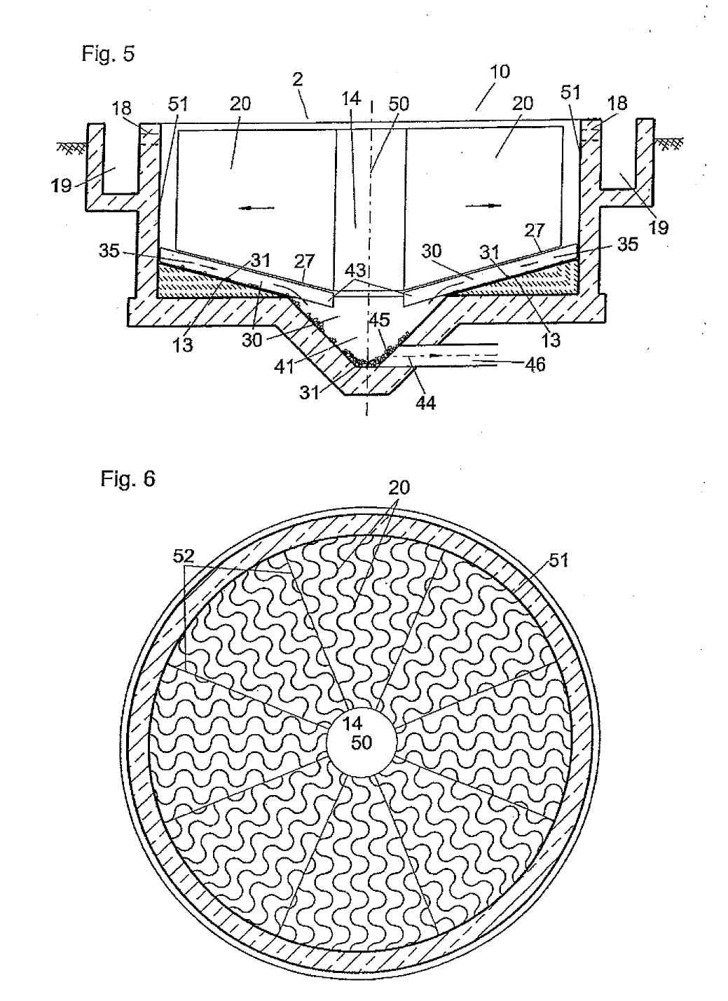

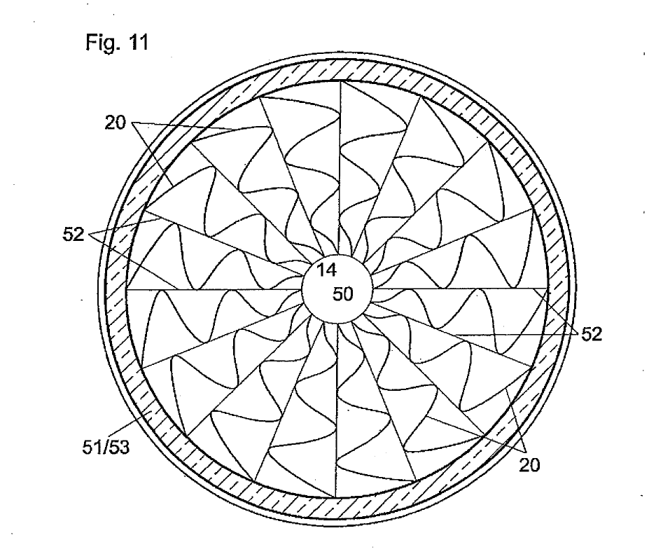

According to FIG. 3, several installations are disposed in the basin 10 as flow guide walls 20, which substantially run in the main flow direction 21. Flow guide walls 20 have a wave 22 or meander 23 structure, as seen in FIG. 4. The crests 24 of the individual waves 22 or meanders 23, that is, the regions of the flow guide walls 20 protruding farthest from the surface, can be oriented substantially perpendicular to the ground 26 (see FIGS. 3, 6, 7, and 9) or, alternatively, parallel thereto (see FIGS. 8 and 10). The flow guide walls 20 extend in the longitudinal direction of the basin 10, that is, in the main flow direction 21, substantially from the inlet region 14 to the outlet region 15, thereby defining settling region 30 of the basin 10. In the vertical direction, the upper edges 25 of the flow guide walls 20 reach from a position above the target waste water level in the basin 10 to the position of the lower edges 27, which extends approximately to the bottom 13 of the basin 10. If the bottom 13 of the basin 10 is raised in the settling region, which is depicted in FIG. 2, the lower edges 27 of the flow guide walls 20 follow the contour of the bottom 13.

A purification apparatus 42 is provided between the lower edge 27 of the flow guide walls 20 and the bottom 13 of the basin 10, and can be used to deliver the sediment 31, which is present on the bottom 13 of the settling region 30, into a sludge collection chamber 41. The purification apparatus 42 is configured, for example, as an arrangement of rake blades 43, which are installed displaceably in the purification region 35 of the basin 10. One or more of the basin bottom 13, the face walls 11, 11a, and the side walls 12 can be provided with openings for feed lines, which are not shown here, by way of which gases or fluids can be introduced into the basin 10.

FIG. 3 shows a schematic illustration of a top view of a sedimentation basin 2 according to the invention. As with the sedimentation basin 2 of FIG. 2, it is a substantially rectangular elongate collection basin. The main flow direction 21 runs from the face wall 11 of the basin 10, which is located on the inlet side, which forms a narrow side, to the opposing face wall 11a. The perpendicularly disposed flow guide walls 20 are shown in a top view, so that it is shown how the crests of the waves 22 or meanders 23 extend. The arrangement of the flow guide walls 20 is such that the waves 22 or meanders 23 run substantially parallel to those of the respectively adjoining flow guide wall 20. In this way, the waste water that is guided between two flow guide walls 20 flows through a meandering, yet substantially uniformly large, cross-section. The distances of the crests 24 of the waves 22 or meanders 23 can be regular or irregular with respect to the longitudinal extension of the flow guide walls 20. As is apparent from FIG. 3, the side walls 12 of the basin 10 can also be provided with structures, which are preferably matched to the shape of the flow guide walls 20.

FIG. 4 shows a flow guide wall 20 in a schematic perspective view. The waves 22 or meanders 23—and therefore the crests 24 thereof—extend in the vertical direction with respect to the ground 26, not shown. The wave trough corresponds to the cut bank 32, and the wave crest forms the point bar 33. Incidentally, a wave crest on one side of a flow guide wall 20 appears as a wave trough on the other side.

Depending on the course of the bottom 13 of the basin 10, the distance between the upper edge 25 and the lower edge 27 of the flow guide walls 20 can be constant or change in the longitudinal direction. The distance is the smallest, having the value A′, in the vicinity of the outlet region 15 of the basin 10. The flow guide walls 20 have holding apparatuses, not shown, which suspend and hold the walls in the basin. The holding apparatuses are preferably mounted on devices which provide for the adjustment and varying of the immersion depth of the flow guide walls 20 in the basin 10.

FIG. 5 shows a schematic illustration of a different design of a sedimentation basin 2 according to the invention. The basin 10 is a circular basin, with the inlet region 14 located in the central region 50. The preferably conical or funnel-shaped sludge collection chamber 41 is disposed beneath the inlet region 14. The settling region 30 extends from the central inlet region 14 to the edge 51 of the basin 10, where the overflow outlet 18 for the waste water 3, from which the sediment 31 has been separated, feeds a duct 19. In the settling region 30 of the basin 10, the flow guide walls 20 are disposed in a suspended manner such that the lower edges 27 thereof maintain a fixed distance from the bottom 13 of the basin 10, with the bottom ascending toward the edge 51. The space provided serves as purification zone 35, in which rotating rake blades 43 or other wiper apparatuses feed the sediment 31 deposited on the bottom 13 to the sludge collection chamber 41. A discharge line 44 having an opening 45, which constitutes part of a sludge extractor 46, opens into the sludge collection chamber 41. The sediment 31 present in the sludge collection chamber 41 can be removed by sludge extractor 64, for example using a spiral conveyor, which is not shown here.

The arrangement of the flow guide walls 20 in a circular basin is substantially radial, which is shown in the schematic top view of FIG. 6. Here, as in the previous figures, the waves 22 or meanders 23 run perpendicular to the ground 26. Since the flow guide walls 20 diverge toward the outside, an arrangement including long flow guide walls 20, which run substantially from the inlet region 14 to the edge 51 of the basin 10, and shorter flow guide walls 20, having different lengths, are provided. In this manner, an at least approximately constant cross-section of flow can be achieved between adjoining flow guide walls 20. Here, the orientations of the individual flow guide walls 20 extend only in the radial main flow direction 21, as is shown in FIG. 6.

The arrangement of the flow guide walls 20 in the basin 10 can also be carried out using flow guide walls 20 that all have the same length, as is shown in FIG. 11. Here, the widening of the flow cross-sections between adjoining flow guide walls 20 is shown, which is caused by the substantially radial orientation of the flow guide walls 20. The widening of the cross-section of flow results in a slowing of the flow toward the outside.

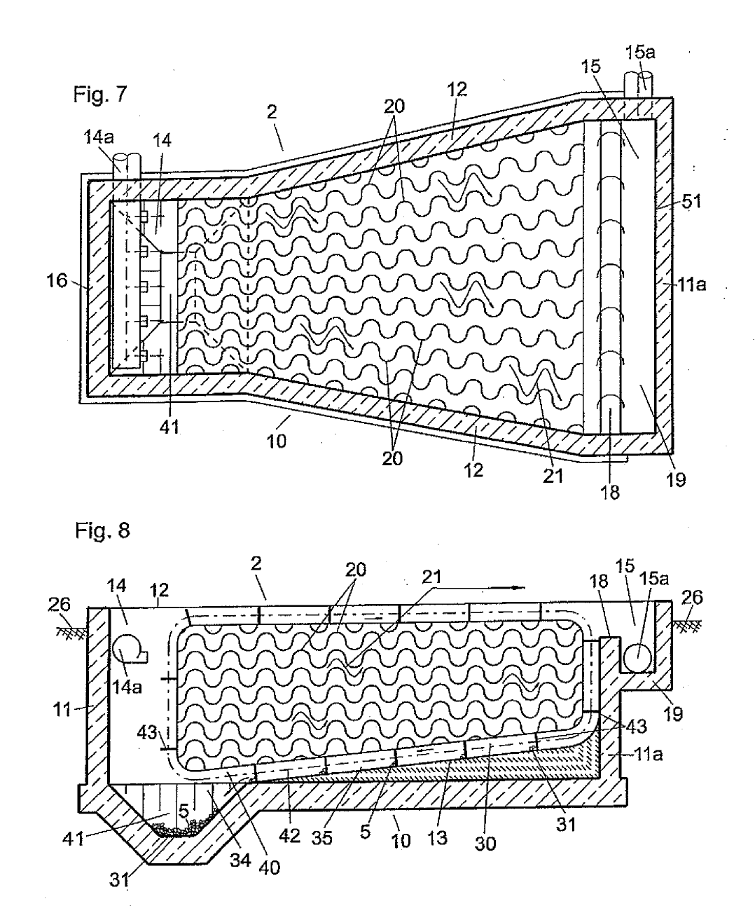

FIG. 7 shows a schematic illustration of a further embodiment of a sedimentation basin 2 according to the invention. Here, the basin 10 is configured as a sector of a circle or a trapezoid. The inlet region 14 is located on the narrow side 16, while the outlet region 15, including the overflow outlet 18 and the duct 19, is disposed at the opposing edge 51 or at the wider face wall 11a. The sludge collection chamber 41 is preferably located beneath the inlet region 14. In principle, the arrangement of the flow guide walls 20 is the same as that of FIG. 6, that is, the flow guide walls 20 run substantially in the main flow direction 21, i.e., radial direction. The side walls 12 of the basin 10 may be smooth, or they can be matched to the shape of the flow guide walls 20, previously described in the embodiment shown in FIG. 3.

FIG. 8 shows a schematic longitudinal section of a rectangular or trapezoidal basin according to a further embodiment of the invention. The flow guide walls 20 are positioned in a stacked arrangement, transverse to the main flow direction 21, such that the flow is diverted substantially vertically. The sediment here preferably settles in the wave troughs or ducts extending transverse to the main flow direction. The sediment is delivered laterally by the ducts to a side wall, by way of gravity. Thus, a sufficient slope is provided in the flow guide walls 20 in the direction of the side wall. It is also possible to use a plurality, for example two, separate arrangements of this type, for example in such a way that the slope of each arrangement is toward the center line of the basin 10. In this embodiment, the sediment collects on the center line of the bottom of the basin, from where it is delivered through the purification apparatus into the sludge collection chamber.

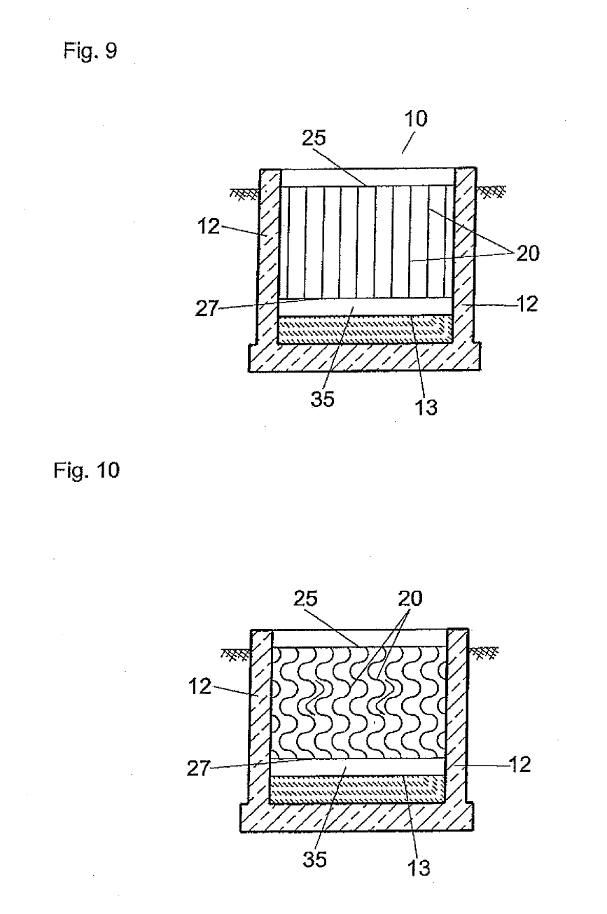

FIG. 9 shows a schematic cross-section of a rectangular or trapezoidal basin, as shown in FIG. 3. The crests 24 of the waves 22 or meanders 23 run in the vertical direction, which is indicated by the vertical lines 20. The distance between the lines corresponds to the width of each individual flow duct.

FIG. 10 shows a schematic cross-section of a rectangular or trapezoidal basin 10 according to a further embodiment of the invention. The crests 24 of the waves 22 or meanders 23 run substantially horizontally and parallel to the main flow direction 21.

In a further embodiment of the invention, it is possible to combine the designs of the flow guide walls 20 according to FIGS. 9 and 10, that is, to run the meanders or waves both vertically and horizontally. In this way, a profile in the manner of a “mogul slope”, which is familiar to skiers, is obtained for the flow guide walls 20. This shape allows for a wide variety of variations when it comes to the arrangement and dimensions of the structures according to the invention on the flow guide walls 20. The basic principle, however, is to reduce the flow rate of the waste water 3 in the basin 10 as a result of the shape of the flow guide walls 20.

FIG. 11 shows a schematic cross-section of a pipe 53 having flow guide walls according to a further embodiment of the invention. Taking into consideration the configuration of a circular basin having meanders 23 running substantially in the radial direction, such an arrangement can also be employed in the form of a pipe 53 for water procurement. For this purpose, the fluid can flow through the pipe 53 from the exterior to the interior, or vice versa. Because of the meander-shaped flow guide walls 20 inside the pipe 53, solid matter, which settles, is separated from the fluid. This arrangement can be used, for example, to obtain drinking water from a river. In a further modification of this variant, (not shown), the meandering flow guide walls 20 run in the longitudinal direction of the pipe 53, which is the same direction in which flow is provided. The pipe 53 is preferably oriented in a vertically or obliquely ascending manner and fluid flows through the pipe from the bottom upward. The sediment then settles predominantly in the lower region of the pipe 53 and can be removed therefrom.

1. A sedimentation basin for sewage treatment plants, comprising a basin having an inlet region for a fluid in need of purification, the fluid comprising an admixture of mineral and organic material; an outlet region for the fluid, whereby fluid flowing through the outlet region includes a lesser amount of the admixture; the basin having a main flow direction for flow of the fluid between the inlet region and the outlet region; guide walls positioned parallel to the main flow direction, the guide walls having a wave shape, whereby the guide walls guide at least part of the fluid in a continuously alternating flow direction;
the basin having a bottom, the bottom having an ascending portion that ascends in the direction of the outlet region, whereby a size of a sedimentation section located at the bottom of the basin is reduced; the guide walls being configured to effect an increase in a cross-section of flow in the main flow direction, which increase in the cross-section of flow in the main flow direction compensates for a reduction of a cross-section of flow caused by the ascending portion of the bottom.

2. The sedimentation basin according to claim 1, wherein the wave shape of the guide walls is configured as a plurality of, crests that extend substantially perpendicular to a ground in which the basin is affixed, the plurality of crests extending transversely to the main flow direction between the inlet region and outlet region.

3. The sedimentation basin according to claim 1, wherein the guide walls extend substantially from an upper edge of the basin to substantially the bottom of the basin.

4. The sedimentation basin according to claim 1, wherein a distance between the bottom of the basin and a lower edge of the guide walls is constant and the distance follows a surface contour of the bottom of the basin.

5. The sedimentation basin according to claim 1, wherein the guide walls are arranged in a substantially parallel configuration.

6. The sedimentation basin according to claim 1, wherein the guide walls are displaceable in a vertical direction.

7. The sedimentation basin according to claim 1, wherein the basin has a substantially rectangular shape, the inlet region and outlet region being respectively located at a first and a second side of the basin, which first side and second side oppose each other.

8. The sedimentation basin according to claim 1, wherein the basin has a trapezoidal shape, the inlet region being positioned on a narrow side of the trapezoidal shape and the outlet region being positioned on a relatively wider side opposite the inlet region.

9. The sedimentation basin according to claim 1, wherein the basin has a substantially circular shape, the inlet region is positioned at a center of the basin, the outlet region is positioned at an edge of the basin, and the guide walls are disposed in a substantially radial configuration.

10. The sedimentation basin according to claim 1, wherein the basin has a shape that is substantially a sector of a circle, the inlet region is positioned at a center of the basin, the outlet region is positioned at an edge of the basin, and the guide walls are disposed in a substantially radial configuration.

11. The sedimentation basin according to claim 1, wherein the basin is provided with a sludge collection chamber located at a lowest portion of the bottom of the basin.

12. The sedimentation basin according to claim 11, comprising a sludge delivery apparatus for delivering sediment collected on the bottom of the basin to the sludge collection chamber.

13. The sedimentation basin according to claim 1, wherein the basin is provided with side walls located between the inlet region and the outlet region, the side walls having a shape corresponding to the wave shape of the guide walls.

14. The sedimentation basin according to claim 1, wherein an inlet is provided at a basin location suitable for dispersing at least one of a gas and a liquid into the fluid.

15. The sedimentation basin according to claim 1, wherein at least a first guide wall and a second guide wall from among the guide walls are respectively provided with a first length and a second length, wherein the first length is not equal to the second length.

16. The sedimentation basin according to claim 1, wherein the guide walls are provided with a minor structure having a size and a dimension affecting flow of the fluid through the basin.

17. The sedimentation basin according to claim 1, wherein the wave shape of the guide walls has a dimension that changes in size relative to the main flow direction.

18. The sedimentation basin according to claim 1, wherein the wave shape of the guide walls has a vertical dimension that increases in size from a top to the bottom of the basin.

19. The sedimentation basin according to claim 1, wherein the basin has a substantially rectangular shape and the inlet region and outlet region are respectively located at a first corner and a second corner of the basin, which first corner and second corner are arranged opposite each other.
